(19) United States
(12) Patent Application Publication
(10) Pub. No.: US 2017/0251666 A1
(43) Pub. Date: Sep. 7, 2017

(54) ONE-PART SOLID GLUTARALDEHYDE-QUATERNARY AMMONIUM INCLUSION OR OCCLUSION COMPLEXES AND THEIR USES

(71) Applicant: Ecolab USA Inc., St. Paul, MN (US)

(72) Inventors: David Daniel McSherry, West St. Paul, MN (US); Benjamin Crew, Eagan, MN (US); Justin Scott Valenstein, Eagan, MN (US)

(21) Appl. No.: 15/450,314

(22) Filed: Mar. 6, 2017

Related U.S. Application Data
(60) Provisional application No. 62/303,718, filed on Mar. 4, 2016.

(51) Int. Cl. A01N 35/02; C09K 8/54; A01N 25/00; A01N 33/12; A01N 25/34

(52) U.S. Cl. CPC A01N 35/02; A01N 33/12; A01N 25/34; A01N 25/002; C09K 8/54; C09K 2208/32

(57) ABSTRACT

A solid glutaraldehyde composition is provided which incorporates a quaternary ammonium compound. The glutaraldehyde can be used in a method of treating a wellbore or a subterranean formation, by introducing the composition to a wellbore or to an injection line within a wellbore in an amount effective to reduce biodegradation of crude oil, reduce corrosion of metal surfaces from sulfur-reducing bacteria, or to reduce the introduction of bacteria into the formation, reduce microbial contamination of a fluid introduced into the wellbore, or reduce microbial contamination of a pipeline.

### CROSS REFERENCE TO RELATED APPLICATIONS

This application claims the benefit of U.S. Provisional Patent Application Ser. No. 62/303,718 filed on Mar. 4, 2016, the disclosure of which is incorporated herein by reference in its entirety.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### REFERENCE TO A SEQUENCE LISTING, TABLE, OR COMPUTER PROGRAM LISTING APPENDIX SUBMITTED ON A COMPACT DISC AND AN INCORPORATION-BY-REFERENCE OF THE MATERIAL ON A COMPACT DISC

Not applicable.

### FIELD OF THE INVENTION

The present invention generally relates to improved solid glutaraldehyde compositions for use as an antimicrobial in the oil and natural gas industry and other antimicrobial control applications.

### BACKGROUND OF THE INVENTION

Microbiological contamination of an oil or natural gas environment can lead to degradation of hydrocarbons, and increased sulfur content and viscosity. These changes adversely impact extraction and processing equipment by causing corrosion and production of hydrogen sulfide and other undesirable substances. Antimicrobial additives have been used to control the growth of microorganisms in such environments. Solid glutaraldehyde antimicrobials derived by forming a hemiacetal derivative with sucrose are described in U.S. Pat. No. 5,158,778. Solid glutaraldehyde has advantageous handling properties since it does not dissolve rapidly, and it has reduced skin and eye splash hazard and lung irritancy as compared to liquid glutaraldehyde. While the existing solid glutaraldehyde composition is an effective antimicrobial, it would be useful to provide a composition with significantly improved antimicrobial efficacy in a reduced hazard, solid form. Since liquid glutaraldehyde splashed in the eyes can lead to partial or complete and permanent loss of vision, a solid form of the composition for use in consumer and industry applications would greatly reduce the otherwise severe eye hazards of the liquid compositions.

### BRIEF SUMMARY OF THE INVENTION

A solid antimicrobial composition is provided. The composition comprises from about 2 to about 70 wt. % glutaraldehyde; from about 10 to about 79.9 wt. % sucrose; from about 0.1 to about 20 wt. % quaternary ammonium compound; and less than 10 wt. % water. The composition is derived from a molten blend comprising the glutaraldehyde, sucrose and quaternary ammonium compound. Preferably, the composition comprises a homogeneous glass comprised of the glutaraldehyde, sucrose and quaternary ammonium compound.

A method of making the solid antimicrobial composition is also provided, the method comprising: adding the sucrose to aqueous glutaraldehyde to form a mixture; heating the mixture to dissolve the sucrose to form a clear homogeneous solution; adding the quaternary ammonium compound to the mixture or the homogeneous solution; and removing volatiles from the solution to form the solid antimicrobial composition.

A method of preserving, sanitizing, disinfecting or sterilizing a contaminated surface or material is provided, the method comprising: exposing the contaminated surface or material to an effective amount of the composition.

Also provided is a method of treating a wellbore or a subterranean formation. The method comprises introducing the composition to a wellbore or to an injection line within a wellbore in an amount effective to reduce biodegradation of crude oil, reduce corrosion of metal surfaces from sulfur-reducing bacteria, or to reduce the introduction of bacteria into the formation, reduce microbial contamination of a fluid introduced into the wellbore, or reduce microbial contamination of a pipeline.

Other objects and features will be in part apparent and in part pointed out hereinafter.

### BRIEF DESCRIPTION OF THE SEVERAL VIEWS OF THE DRAWING

FIG. 1 is a graph which depicts the log reduction in P. aeruginosa survivors when treated with 2×70 ppm duplicates of solid glutaraldehyde (-♦- and -▪-), 70 ppm solid glutaraldehyde containing quaternary ammonium compound (-▴-), or untreated control (-X-).

FIG. 2 is a graph which depicts the log reduction in P. aeruginosa survivors when treated with 50 ppm of solid glutaraldehyde (-▪-), 70 ppm solid quaternary ammonium compound (-▴-), or untreated control (-♦-).

### DETAILED DESCRIPTION OF THE INVENTION

A solid antimicrobial composition is provided which includes a combination of glutaraldehyde and a quaternary ammonium compound as antimicrobials. Although such an antimicrobial combination is known, existing combinations are liquid rather than solid. The composition is derived from a molten blend comprising the glutaraldehyde, sucrose and quaternary ammonium compound. It was unexpected that a melt of glutaraldehyde and sucrose would act as a solvent for the quaternary ammonium compound such that the quaternary ammonium compound would dissolve in the melt. When the melt solidifies, it forms a hard, clear homogenous candy type of glass at room temperature. The solubility and compatibility observed is surprising because sucrose is not itself soluble in molten solid glutaraldehyde and thus it was surprising that a quaternary ammonium compound would have solubility.

The molten blend from which the composition is derived can be a hemiacetal composition comprising the glutaraldehyde, sucrose and entrapped or occluded quaternary ammonium compound. While not being bound to a particular theory, it is believed that hemiacetal bonds form between the sucrose and glutaraldehyde within the molten blend and that the high polarity of the hydroxyl and/or hemiacetal oxygens solvate the polar quaternary ammonium cation of the quaternary ammonium compound.

The solid antimicrobial composition comprises from about 2 to about 70 wt. % glutaraldehyde; from about 10 to about 79.9 wt. % sucrose; from about 0.1 to about 20 wt. % quaternary ammonium compound; and less than 10 wt. % water.

Preferably, the composition comprises a homogeneous glass comprised of the glutaraldehyde, sucrose and quaternary ammonium compound. The glass can be visually transparent.

The glass transition temperature of the composition is at least 20° C., and preferably greater than 20° C., such as at least 25, 30, 35, 40, 45, 50, 55 or 60° C.

The glass transition temperature of the composition is impacted principally by its glutaraldehyde and water content. Addition of a quaternary ammonium compound further depresses the glass transition temperature. If the composition contains more than about 70 wt. % glutaraldehyde, its glass transition temperature may be too low, which can result in breakage or deformation of the composition during normal handling. While deformation does not necessitate a loss in activity it may make handling the product problematic. In applications where the product is in a container of sufficient strength or rigidity a low glass transition temperature is more tolerable. When a low glass transition temperature is more tolerable, glutaraldehyde activity and/or quaternary ammonium compound content can be maximized.

The water content of the composition should not exceed about 10 wt. % or the Tg of the composition may be excessively depressed. A water content of about 5, 4, 3 or 2 wt. % is preferred.

The composition can comprise from about 30 to about 60 wt. % glutaraldehyde; from about 20 to about 60 wt. % sucrose; from about 10 to about 20 wt. % quaternary ammonium compound; and less than 5 wt. % water. Preferably, the composition comprises from about 30 to about 50 wt. % glutaraldehyde; from about 30 to about 50 wt. % sucrose; from about 12 to about 18 wt. % quaternary ammonium compound; and less than 4 wt. % water.

The quaternary ammonium compound selected for the composition is soluble in the molten solid glutaraldehyde as well as in the aqueous glutaraldehyde solution. For purposes of this invention, a compound is “soluble” in the aqueous glutaraldehyde solution if the mixture is transparent and appears homogenous.

Suitable quaternary ammonium compounds include, but are not limited to, those having the formula:

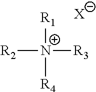

wherein R₁ is lower alkyl, C₈-C₃₀ alkyl or alkaryl; R₂ is lower alkyl or C₈-C₃₀ alkyl; R₃ is alkaryl; ₄ is C₈-C₃₀ alkyl; and X⁻ is an anion. Preferably, R₁ and R₂ are each independently methyl or C₈-C₂₂ alkyl; R₃ is benzyl; and R₄ is C₈-C₂₂ alkyl; R₁ and R₂ are methyl; R₃ is benzyl; and R₄ is C₈-C₂₂ alkyl; R₁ is methyl, R₂ and R₃ are benzyl; and R₄ is C₈-C₂₂ alkyl; or R₁, R₂ and R₄ are each C₈-C₂₂ alkyl, and R₃ is benzyl. X⁻ of the quaternary ammonium compound can be any anion, such as a halide, a sulfate, a nitrate, a nitrite, a carbonate, or a carboxylate. Preferably, the anion is a halide such as chloride.

The quaternary ammonium compound can comprise benzyl dimethyloctadecylammonium chloride, benzyl dimethylhexadecylammonium chloride, benzyl dimethyltetradecylammonium chloride, benzyl dimethyldodecylammonium chloride, benzyl dimethyldecylammonium chloride, benzyl dimethyloctylammonium chloride, didecyldimethylammonium chloride (DDAC), or a combination thereof. A mixture of such compounds is commercially available as benzalkonium chloride.

The quaternary ammonium compound can comprise benzyl dimethylhexadecylammonium chloride, benzyl dimethyltetradecylammonium chloride, benzyl dimethyldodecylammonium chloride, or a combination thereof. For example, JAQ™ Powdered Quat (white crystalline powder typically containing 98% N-alkyl (C₁₄ 95%, C₁₆ 2%, C₁₂ 3%) dimethyl benzyl ammonium chloride) is commercially available from Lonza Inc. (Allendale, N.J.).

Since antimicrobial efficacy of quaternary ammonium compounds is known to be sensitive to water hardness ions such as calcium ions, the addition of a chelant or builder compound, such as ethylenediaminetetraacetic acid (EDTA) or editronic acid, may further increase antimicrobial efficacy.

Beyond the convenience and improved safety provided by the composition, the solubility of the quaternary ammonium compound in the molten glutaraldehyde solution, provides uniformity of actives needed for products registered with the appropriate regulatory authority such as the EPA.

While sucrose is used to produce the composition, crystalline sucrose is not soluble in molten glutaraldehyde, and settles to the bottom of such solid castings rendering the product non-uniform.

Additional compounds that can be added to the compositions before casting include tracing compounds, such as fluorescent dyes, corrosion inhibitors such as imidazoles, anti-scalants such as phosphonates, and pH modifiers such as acids or bases.

The composition can be in the form of a rod, a powder, a block, pastilles or granules or a pressed or extruded solid made from the powder, pastilles or granules.

The composition is not a physical blend (i.e., mechanical blend) of a solid quaternary ammonium compound and a solid hemiacetal composition containing glutaraldehyde and sucrose as described, for example, in U.S. Pat. No. 5,158,778. A physical blend does not involve interaction of the solid quaternary ammonium compound and the solid hemiacetal composition. The composition described herein involves interaction of the solid quaternary ammonium compound and the solid hemiacetal composition.

Preferably, the composition does not contain a silica.

A method of making the solid antimicrobial composition as described herein is also provided. The method comprises adding the sucrose to aqueous glutaraldehyde to form a mixture; heating the mixture to dissolve the sucrose to form a clear homogeneous solution; adding the quaternary ammonium compound to the mixture or the solution; and removing volatiles from the solution to form the solid antimicrobial composition.

Optionally, volatiles can be removed from the clear homogenous solution before addition of the quaternary ammonium compound, preferably under reduced pressure and heat. Since quaternary ammonium compounds tend to form foamy solutions, especially under reduced pressure, it is preferable to remove most or all of the water before addition of the quaternary ammonium compound. Preferably, quaternary ammonium compounds having low water content are used in the compositions. Since aromatic quaternary ammonium compounds typically produce higher melting solids, the aromatic quaternary ammonium compounds (e.g., JAQ™ Powdered Quat) are the preferred quaternary ammonium compounds for such an application.

Another method of making the solid antimicrobial composition as described herein comprises adding the sucrose to aqueous glutaraldehyde to form a mixture; heating the mixture to dissolve the sucrose to form a clear homogeneous solution; evaporating the majority of the water to form a concentrate; adding the quaternary ammonium compound to the concentrate; and removing any remaining volatiles from the concentrate to form the solid antimicrobial composition.

The composition as described herein can be a solid solution or melt containing the glutaraldehyde, sucrose and quaternary ammonium compound as the composition is made.

The composition can be made, for example, by adding sucrose (99% purity) to aqueous glutaraldehyde (50% glutaraldehyde in water) to form a mixture; heating the mixture to dissolve the sucrose to form a clear homogeneous solution; adding the quaternary ammonium compound to the mixture or the solution; and removing volatiles from the solution by rotary evaporation to form the solid antimicrobial composition.

A method of preserving, sanitizing, disinfecting or sterilizing a contaminated surface or material is also provided. The method comprises exposing the contaminated surface or material to an effective amount of the composition as described herein.

The contaminated surface or material can be at least a portion of a cooling water system, a heating, ventilation or air conditioning system, medical equipment, dental equipment, food and beverage handling equipment, a food or beverage container, a textile, clothing, a mining operation, a hydraulic fracturing operation, a gas storage system, an oil storage system, a phase separation system or tank, a pipeline pigging operation, an oil well, a crude oil, a natural gas stream, a refined oil, an injection fluid, a pipeline, a drilling fluid, a fracturing fluid, produced water or animal hooves or teats. For example, the composition can be used to treat livestock hooves or teats by sanitizing the hooves or teats or by assisting healing of the infected surface.

A method of treating a wellbore or a subterranean formation is also provided. The method comprises introducing the composition as described herein to a wellbore or to an injection line within a wellbore in an amount effective to reduce biodegradation of crude oil, reduce corrosion of metal surfaces from sulfur-reducing bacteria, to reduce the introduction of bacteria into the formation, reduce microbial contamination of a fluid introduced into the wellbore, or reduce microbial contamination of a pipeline.

The composition can be introduced at a dosage rate of about 5 to about 10,000 ppm as active glutaraldehyde, more preferably at a dosage rate of about 30 to about 6,000 ppm as active glutaraldehyde, or most preferably at a dosage rate of about 30 to about 3,000 ppm as active glutaraldehyde.

The compositions can be used in various ways, preferably in solid soluble block form, including use as hard surface disinfectants, sanitizers such as those used in the food and beverage industry, cold sterilants such as those used in the health care industry, or antimicrobials such as used in pest elimination, textile care and laundry, paper and mining industries.

Unless otherwise indicated, a “glass” means any of various amorphous materials formed from a melt by cooling to rigidity without crystallization.

An “alkyl” group as described herein alone or as part of another group is an optionally substituted linear saturated monovalent hydrocarbon radical containing from one to thirty carbon atoms and preferably eight to thirty carbon atoms, or an optionally substituted branched saturated monovalent hydrocarbon radical containing three to thirty carbon atoms, and preferably eight to thirty carbon atoms. The term “lower alkyl” is an optionally substituted linear saturated monovalent hydrocarbon radical containing from one to six carbon atoms, or an optionally substituted branched saturated monovalent hydrocarbon radical containing three to six carbon atoms. Examples of unsubstituted lower alkyl groups include methyl, ethyl, n-propyl, i-propyl, n-butyl, i-butyl, s-butyl, t-butyl, n-pentyl, i-pentyl, s-pentyl, t-pentyl, and the like.

An “alkaryl” group denotes a group containing both alkyl and aryl structures such as benzyl.

The term “aryl” as used herein alone or as part of another group denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are the more preferred aryl.

As used herein, the alkyl, aryl and alkaryl groups can be substituted with at least one atom other than carbon, including moieties in which a carbon chain atom is substituted with a hetero atom such as nitrogen, oxygen, silicon, phosphorous, boron, sulfur, or a halogen atom. These substituents include hydroxy, nitro, amino, amido, nitro, cyano, sulfoxide, thiol, thioester, thioether, ester and ether, or any other substituent which can increase the solubility or compatibility of the quaternary ammonium compound and/or its efficacy enhancement in the solid glutaraldehyde composition without adversely affecting the solubility or compatibility of the quaternary ammonium compound in the sucrose/glutaraldehyde mixture or the homogeneous solution when the composition is being made. One of ordinary skill in the art would also recognize that any substituents or heteroatoms should be appropriate for the intended use of the composition (e.g., not a substituent known to cause corrosion in equipment used in the oil and gas industry).

Having described the invention in detail, it will be apparent that modifications and variations are possible without departing from the scope of the invention defined in the appended claims.

### EXAMPLES

The following non-limiting examples are provided to further illustrate the present invention.

### Example 1

### 100% Solid Glutaraldehyde Comparative Product

A conventional solid glutaraldehyde composition was made by adding 5415 grams of 50% aqueous glutaraldehyde, followed by addition of 1815 grams of sucrose (99% purity) to a two gallon stainless steel kettle equipped with internal and external heating. The reactor was heated until the solution reached 80° C. forming a clear homogeneous solution, and then vacuum was applied. Stripping continued until about 2572 grams of distillate was collected. Upon cooling the reaction solution, a hard, clear candy-like glass formed. The glass transition temperature of the product ranged from 45-55° C. Its viscosity at 80° C. was about 1,000 cP, and its glutaraldehyde activity was ˜45% based on 3-methyl-2-benzothiazolinone hydrazone (MBTH) assay method.

### Example 2

### Solid 10% Quaternary Ammonium/90% Glutaraldehyde Candy Glass Product

A homogenous solid glutaraldehyde glass was made by adding 90 grams of the solid glutaraldehyde of Example 1 to a flask immersed in a 90° C. water bath. After the solid glutaraldehyde melted (at about 70° C.), 10 grams of JAQ™ Powdered Quat was added to the melt. The JAQ powder was observed to melt quickly and resulted in a clear melt with occluded air bubbles. To confirm complete dissolution had occurred and to produce a bubble-free glass, the melt was added to 50 mL centrifuge tubes and it was spun at about 3000 rpm for about one minute after which the tubes were placed in a freezer. This procedure was repeated again at 200% of the preceding scale and the clear, cooled melt produced a clear hard glass with a glass transition temperature greater than or equal to 50° C.

Examples 1 and 2 used a relatively high ratio of glutaraldehyde to sucrose thereby maximizing glutaraldehyde activity. As previously noted in U.S. Pat. No. 5,158,778, higher ratios of glutaraldehyde to sucrose depress the melting point of the solid glutaraldehyde candy glass. Additional components typically depress the melting point or Tg of the candy glass. Therefore to maximize quaternary ammonium content of a solid glutaraldehyde candy glass it is most efficient to offset the effect of the quaternary ammonium compound addition by increasing the sucrose content as compared to a solid glutaraldehyde candy glass which does not contain a quaternary ammonium compound. In Examples 3 and 4, the base formula of solid glutaraldehyde was modified to increase the sucrose/glutaraldehyde ratio to provide a higher quaternary ammonium content than the 10% found in Example 2.

### Example 3

### Solid 10% Quaternary Ammonium/90% Glutaraldehyde Candy Glass Product

A solid glutaraldehyde composition was made by adding 3000 grams of 50% aqueous glutaraldehyde, followed by addition of 1820 grams of sucrose (99% purity) to a two gallon stainless steel kettle equipped with internal and external heating. The reactor was heated until the solution reached about 80° C. forming a clear homogeneous solution and vacuum was applied until 1744 grams of condensate was collected (36% of the initial charge mass). To the molten product 342 grams of a quaternary ammonium powder (JAQ™ Powdered Quat) (10.0 wt. % relative to the residual contents) was added to the molten mixture before mixing for several minutes and removing a 114 gram sample. The sample turned to a hard candy glass as described in Example 2.

### Example 4

### Solid 20% Quaternary Ammonium/80% Glutaraldehyde Candy Glass Product

In order to achieve 10% additional quaternary ammonium content, to the remaining 3304 g of molten mixture, an additional 329 g of quaternary ammonium (JAQ™ Powdered Quat) was added to the molten product of Example 3 followed by several minutes of mixing. The sample turned to a hard candy glass as described in Example 2.

In Examples 1-4 all of the products could be described as solid candy glasses with melting points significantly greater than 20° C. and transparent in appearance. The details of the examples are provided in Table 1.

TABLE 1

| | | | | Initial | Residual | | |
|---|---|---|---|---|---|---|---|
| | 50% | | | Residual | Glut. | | Quat- |
| | Glut. | Sucrose | Distillate | Product | Activity | Quat | Activity |
| Ex. | (g) | (g) | (g) | (g) | (wt. %) | (g) | (wt. %) |
| 1 | 5415 | 1815 | 2572 | 4658 | 50% | 0 | 0 |
| 2 | | | | 90 | 45% | 10 | 10% |
| 3 | 3000 | 1820 | 1744 | 3076 | 37% | 342 | 10% |
| 4 | | | | 2962 | 33% | 329 | 20% |

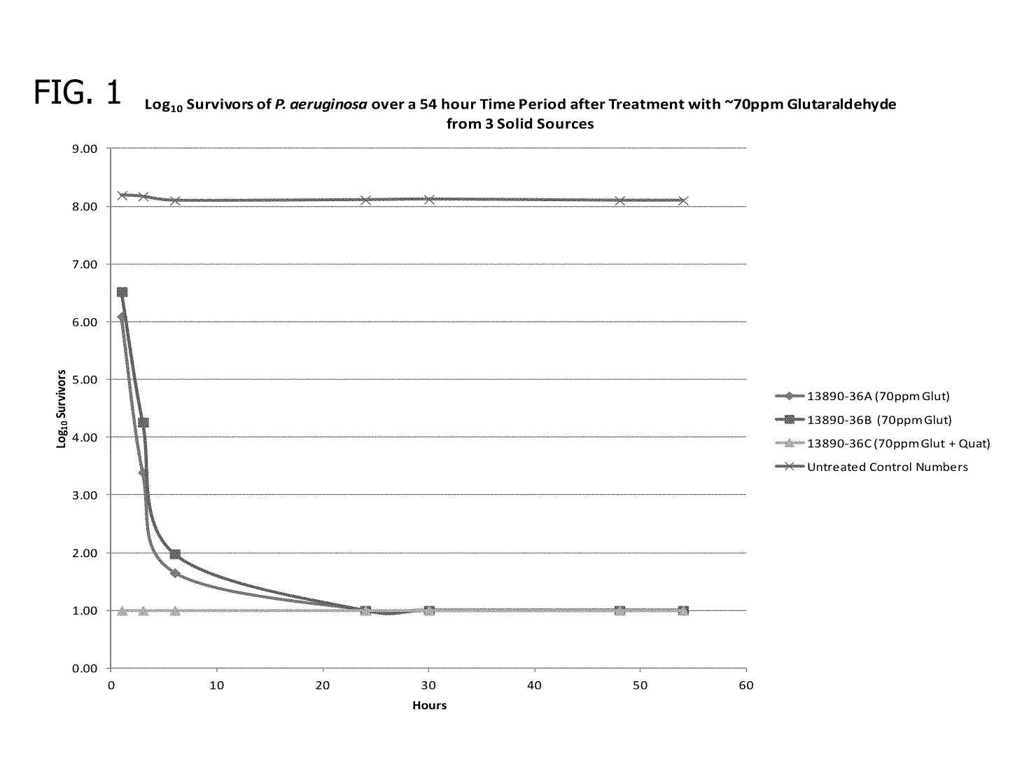

In comparing the conventional solid glutaraldehyde of Example 1 to the solid glutaraldehyde of the invention as in Example 2, the addition of quaternary ammonium compound was significantly more effective in killing Pseudomonas aeruginosa in samples of oil field contaminated water. FIG. 1 shows the comparative kill of P. aeruginosa over a 54 hour period following treatment with 70 ppm glutaraldehyde using two solid glutaraldehyde compositions similar to that of Example 1 and a solid glutaraldehyde composition containing a quaternary ammonium compound similar to that of Example 2. As can be seen in the figure, log reduction of P. aeruginosa was about 1.5-2 at one hour, 6-6.5 at about 6 hours, and about 7 at about 24 hours for the solid glutaraldehyde samples. When a quaternary ammonium compound was present in the solid glutaraldehyde, log reduction of P. aeruginosa was about 8 within one hour and was maintained for the full 54 hour test period. No kill was observed in untreated controls.

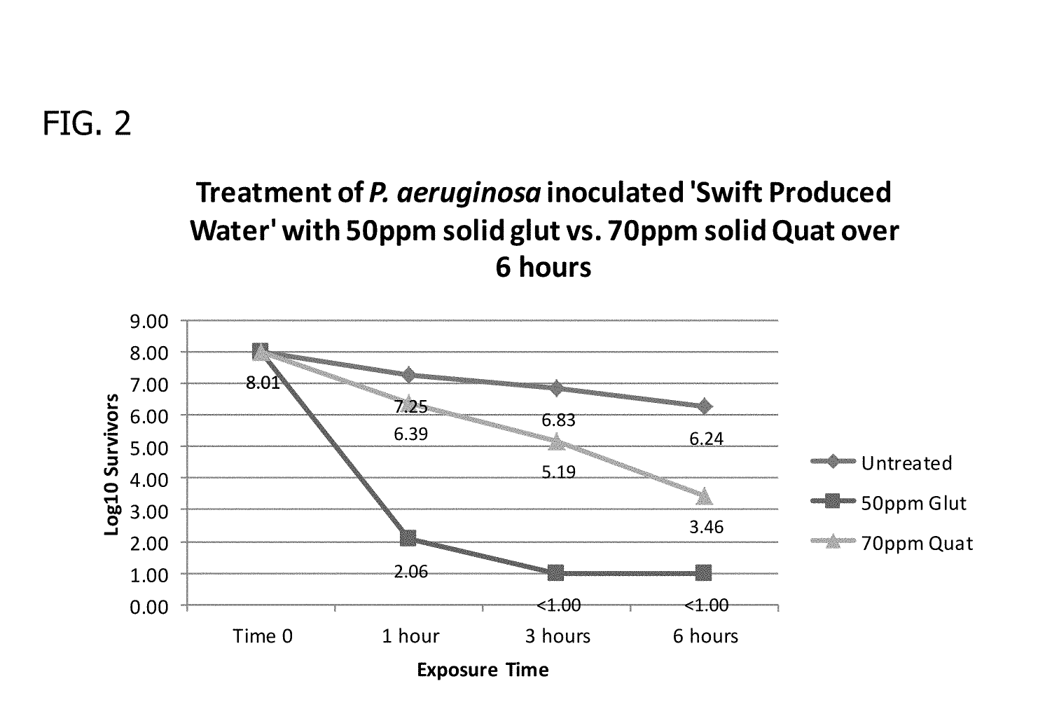

FIG. 2 shows the comparative kill of P. aeruginosa over a 6 hour period following treatment with 50 ppm glutaraldehyde similar to that of Example 1 and a solid quaternary ammonium compound. As can be seen in the figure, log reduction of P. aeruginosa was about 6 at one hour, about 7 at 3 hours, and about 7 at about 24 hours for the solid glutaraldehyde samples, and log reduction of P. aeruginosa was about 1.6 at one hour, about 2.8 at 3 hours, and about 7 at about 24 hours for the solid quaternary ammonium compound samples. For the untreated controls, log reduction of P. aeruginosa was about 0.7 at one hour, about 1.2 at 3 hours, and about 1.8 at about 24 hours. In comparing the results of FIG. 1 and FIG. 2, the inventive compositions are significantly more efficacious for killing P. aeruginosa than solid glutaraldehyde or solid quaternary ammonium.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and processes without departing from the scope of the invention, it is intended that all matter contained in the above description shall be interpreted as illustrative and not in a limiting sense.

1. A solid antimicrobial composition comprising:
from about 2 to about 70 wt. % glutaraldehyde;
from about 10 to about 79.9 wt. % sucrose;
from about 0.1 to about 20 wt. % quaternary ammonium compound; and
less than 10 wt. % water,
wherein the composition is derived from a molten blend comprising the glutaraldehyde, sucrose and quaternary ammonium compound.

2. The composition of claim 1, wherein the composition comprises a homogeneous glass comprised of the glutaraldehyde, sucrose and quaternary ammonium compound.

3. The composition of claim 1, wherein the glass transition temperature of the composition is at least 20° C.

4. The composition of claim 1, comprising from about 30 to about 60 wt. % glutaraldehyde; from about 20 to about 60 wt. % sucrose; from about 10 to about 20 wt. % quaternary ammonium compound; and less than 5 wt. % water.

5. The composition of claim 1, wherein the quaternary ammonium compound has a melting point of at least 40° C.

6. The composition of claim 1, wherein the quaternary ammonium compound is an anhydrous crystalline solid or a crystalline solid hydrate.

7. The composition of claim 1, wherein the quaternary ammonium compound has the formula: 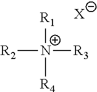
wherein:
R₁ is lower alkyl, C₈-C₃₀ alkyl or alkaryl;
R₂ is lower alkyl or C₈-C₃₀ alkyl;
R₃ is alkaryl;
R₄ is C₈-C₃₀ alkyl; and
X⁻ is an anion.

8. The composition of claim 7, wherein R₁ and R₂ are each independently methyl or C₈-C₂₂ alkyl; R₃ is benzyl; and R₄ is C₈-C₂₂ alkyl.

9. The composition of claim 7, wherein R₁ and R₂ are methyl; R₃ is benzyl; and R₄ is C₈-C₂₂ alkyl.

10. The composition of claim 7, wherein R₁ is methyl, R₂ and R₃ are benzyl; and R₄ is C₈-C₂₂ alkyl.

11. The composition of claim 7, wherein R₁, R₂ and R₄ are each C₈-C₂₂ alkyl, and R₃ is benzyl.

12. The composition of claim 1, wherein the quaternary ammonium compound comprises benzyl dimethyloctadecylammonium chloride, benzyl dimethylhexadecylammonium chloride, benzyl dimethyltetradecylammonium chloride, benzyl dimethyldodecylammonium chloride, benzyl dimethyldecylammonium chloride, benzyl dimethyloctylammonium chloride or a combination thereof.

13. The composition of claim 1, wherein the quaternary ammonium compound comprises benzyl dimethylhexadecylammonium chloride, benzyl dimethyltetradecylammonium chloride, benzyl dimethyldodecylammonium chloride, or a combination thereof.

14. The composition of claim 1, wherein the quaternary ammonium compound comprises benzalkonium chloride or didecyldimethylammonium chloride.

15. (canceled)

16. The composition of claim 1, wherein the composition is in the form of a rod, a powder, a block, pastilles or granules, or a pressed or extruded solid made from powder, pastilles or granules.

17. The composition of claim 1, wherein the composition does not contain a silica.

18. The composition of claim 1, wherein the quaternary ammonium compound is soluble in an aqueous glutaraldehyde solution at a temperature of at least 20° C.

19. A method of making the solid antimicrobial composition of claim 1, the method comprising:
adding the sucrose to aqueous glutaraldehyde to form a mixture;
heating the mixture to dissolve the sucrose to form a clear homogeneous solution;
adding the quaternary ammonium compound to the mixture or the solution; and
removing volatiles from the solution to form the solid antimicrobial composition.

20.-21. (canceled)

22. A method of preserving, sanitizing, disinfecting or sterilizing a contaminated surface or material, the method comprising:
exposing the contaminated surface or material to an effective amount of the composition of claim 1.

23. (canceled)

24. A method of treating a wellbore or a subterranean formation, the method comprising:
introducing the composition of claim 1 to a wellbore or to an injection line within a wellbore in an amount effective to reduce biodegradation of crude oil, reduce corrosion of metal surfaces from sulfur-reducing bacteria, or to reduce the introduction of bacteria into the formation, reduce microbial contamination of a fluid introduced into the wellbore, or reduce microbial contamination of a pipeline.

25.-27. (canceled)
